(19) United States
(12) Patent Application Publication
(10) Pub. No.: US 2009/0285603 A1
(43) Pub. Date: Nov. 19, 2009

(54) Toner Distribution Device For An Image Forming Apparatus

(76) Inventors: Michael Craig Leemhuis, Nicholasville, KY (US); David Krzyzanowski, Lexington, KY (US)

Correspondence Address: John J. McArdle, Jr.;Lexmark International, Inc., Intellectual Property Department, 740 West New Circle Road, Lexington, KY, 40550, US

(21) Appl. No.: 12/120,669

(22) Filed: May 15, 2008

(51) Int. Cl. G03G 15/08

(52) U.S. Cl. 399/256

(57) ABSTRACT

The present application is directed to devices to move toner within a toner reservoir of an image forming apparatus. The devices may include an elongated auger with a helical blade to move the toner. A gutter may be positioned adjacent to the auger and include a bottom section positioned vertically below the auger and a sidewall that extends upward along a lateral side of the auger. Apertures may be positioned along the bottom section of the gutter. The apertures may be sized to allow toner that is moved by the auger to fall through the gutter and into the reservoir

### BACKGROUND

The present application is directed to devices and methods for moving toner in an image forming apparatus, and more particularly to devices and methods for distributing toner along a length of a developer reservoir.

Previous image forming apparatus stored toner within a toner reservoir that was part of a larger toner cartridge. The toner cartridge may also have included other functional elements such as a developer roll, photoconductive roll, and doctor blade. The size of the reservoir was chosen so that the functional elements had approximately the same lifespan as the supply of toner. However, as the lifespan of the functional elements has improved, the size of the toner reservoir has increased. This increase resulted in larger toner cartridges, larger media paths, and overall larger image forming apparatus.

To overcome this problem, image forming apparatus include a toner storage member that supplies toner to the toner reservoir in the toner cartridge. This has allowed the toner reservoir and hence the overall size of the toner cartridge to remain relatively small. The toner from the storage member supplies the toner through an inlet in the toner reservoir where it is then used for producing a toner image.

A drawback of the separate toner storage member is the toner is not evenly distributed along a length of the toner reservoir. Rather, the toner is introduced at one end of the toner reservoir and either is not distributed along the length, or becomes worked due to being moved within the toner reservoir through repetitive contact with one or more toner distribution members. This uneven distribution of the toner results in print defects that are normally seen by a user as uneven coloring or shading across a width of a printed image.

### SUMMARY

The present application is directed to devices and methods to distribute toner across a toner reservoir. An auger and gutter may be positioned at the inlet into the toner reservoir and may be at a vertically elevated section of the toner reservoir. The auger may rotate to move the toner from the inlet and across a section or entirety of the reservoir. The gutter may be positioned vertically below the auger to facilitate the movement of the toner. Apertures may extend through the gutter to cause the toner to fall via gravity into a lower section of the reservoir. The apertures may be spaced along a section or entirety of the gutter to distribute the toner throughout the reservoir.

The various aspects of the various embodiments may be used alone or in any combination, as is desired.

### BRIEF DESCRIPTION OF THE DRAWINGS

FIG. 1 is a perspective view of an auger and gutter positioned within a toner reservoir according to one embodiment.

FIG. 2 is a schematic side view of an auger and gutter positioned within a toner reservoir according to one embodiment.

FIG. 3 is a perspective view of an auger and gutter according to one embodiment.

FIG. 4 is a perspective view of a gutter according to one embodiment.

FIG. 5A is a perspective view of a gutter according to one embodiment.

FIG. 5B is a perspective view of a gutter according to one embodiment.

FIG. 5C is a perspective view of a gutter according to one embodiment.

FIG. 5D is a perspective view of a gutter according to one embodiment.

FIG. 6 is a schematic side view of an image forming apparatus according to one embodiment.

FIG. 7 is a perspective view of toner cartridges and developer units mounted in a frame according to one embodiment.

FIG. 8 is a schematic side view of a toner reservoir according to one embodiment.

### DETAILED DESCRIPTION

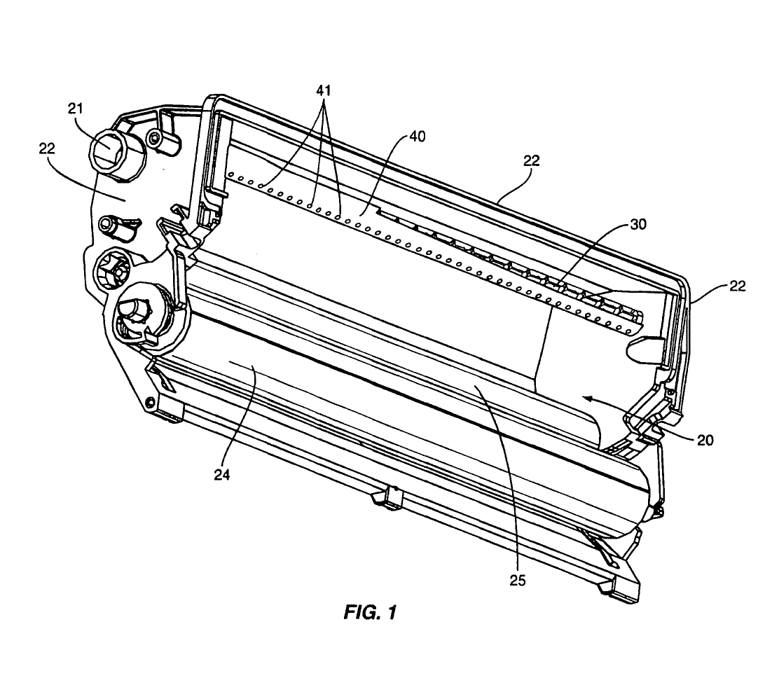

The present application is directed to distribution devices for distributing toner within a toner reservoir in an image forming apparatus. FIG. 1 illustrates one embodiment of the device that includes an auger 30 and gutter 40 that extend across the toner reservoir 20. The auger 30 and gutter 40 are positioned at a vertically elevated section of the toner reservoir 20. The auger 30 rotates to move the toner from an inlet 21 across the length in the reservoir 20. The gutter 40 is positioned vertically below the auger 30 and facilitates the movement of the toner across the length. Apertures 41 in the gutter 40 cause the toner to fall via gravity into a lower section of the reservoir 20. The apertures 41 are spaced along the length of the gutter 40 to distribute the toner within the reservoir 20.

The reservoir 20 is sized to contain an adequate amount of toner for the image forming process. The reservoir 20 includes a plurality of sidewalls 22 that are connected together to form an enclosed interior space that holds the toner. FIG. 1 includes one of the sidewalls 22 removed to allow viewing of the interior space. The reservoir 20 includes a vertical drop from the inlet 21 to the lower section.

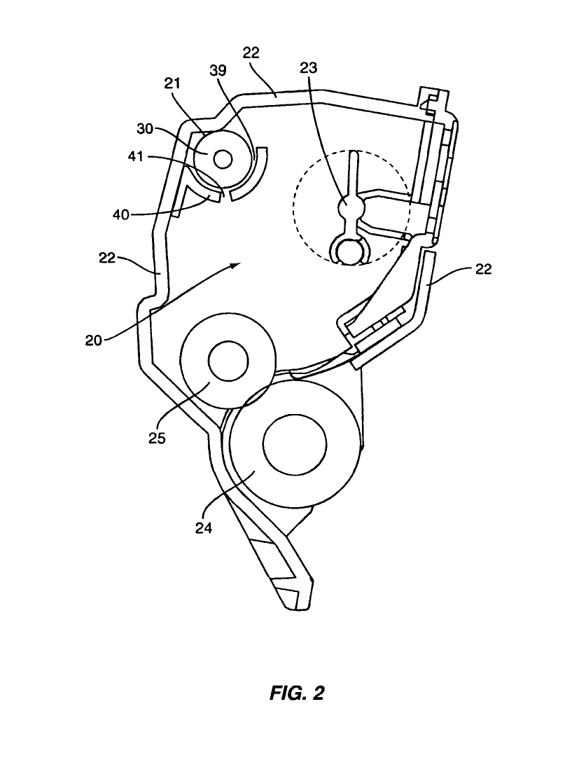

As illustrated in FIG. 2, a metering member 23 may be positioned to rotate within the toner reservoir 20 and agitate and/or move the toner. The metering member 23 may include various combinations of shafts, arms, blades, etc. The toner reservoir 20 may also include one or more functional elements used to create the toner image. In the embodiments of FIGS. 1 and 2, a developer roll 24 and a toner adder roll 25 are positioned in a lower section of the toner reservoir 20 vertically below the inlet 21. One embodiment of a toner reservoir is disclosed in U.S. patent application Ser. No. 11/686,658 filed on Mar. 15, 2007, assigned to Lexmark International Inc., and is herein incorporated by reference.

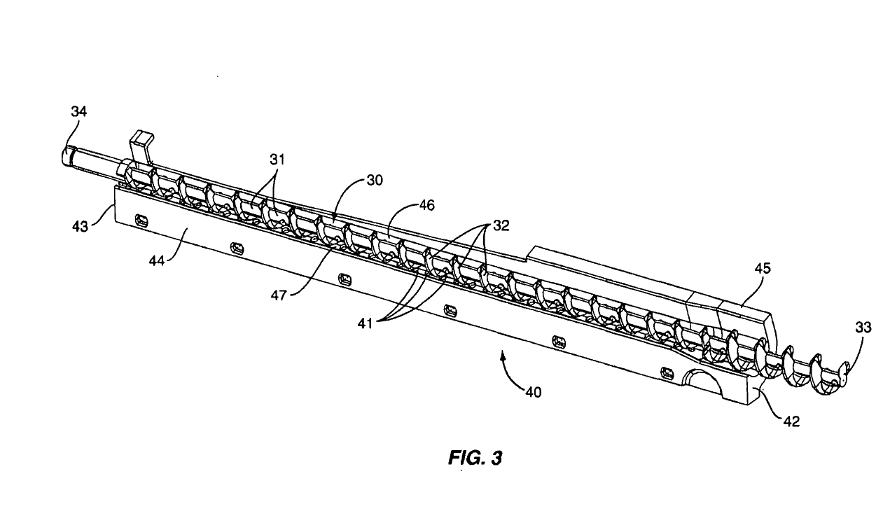

The auger 30 moves the toner from the inlet 21 and along a length of the toner reservoir 20. FIG. 3 illustrates one embodiment of the auger 30 including a shaft 31 and helical blades 32. In another embodiment (not illustrated) the auger 30 is a coiled wire. The auger 30 includes a first end 33 positioned at the inlet 21, and an opposite second end 34. In one embodiment as illustrated in FIG. 3, the first end 33 extends outward beyond the gutter 40 to extend into the inlet 21.

The embodiment of FIG. 3 includes a section at the first end 33 including a larger outer diameter than the remainder of the auger 30. In one embodiment, the outer diameter of the first section is about 11 mm, and the outer diameter of the remainder is about 7.5 mm. The larger diameter facilitates the auger 30 moving the toner into the toner reservoir 20. In one embodiment, the larger diameter section extends along about the first one-half inch of the auger 30.

The blades 32 may not extend the entire length of the shaft 31 as illustrated in FIG. 3. The non-bladed second end 34 may abut against an inner edge of the sidewall 22 opposite from the inlet 21. In another embodiment, the second end 34 extends through an aperture in the sidewall 22 such that the blades 32 extend to the inner edge of the sidewall 22. The section that extends outward from the sidewall 22 may be equipped with a gear to receive rotational force to rotate the auger 30. The auger 30, metering member 23, developer roll 24, and toner adder roll 25 may each be connected together through a gear train and driven by a common motor. The auger 30 may extend across the entire length of the toner reservoir 20, or just along a limited section of the toner reservoir 20.

The gutter 40 provides support for moving the toner from the inlet 21 and along the toner reservoir 20. The gutter 40 includes a first end 42 that is positioned against the inner edge of the sidewall 22 at the inlet 21, and a second end 43 that is positioned against the inner edge of the sidewall that is opposite from the inlet 21. In another embodiment, the gutter 40 includes a length that is less than the length of the toner reservoir 20. The first end 42 is positioned against the inner edge of the sidewall 22 at the inlet 21, and the second end 43 stops at a point within the interior of the toner reservoir 20.

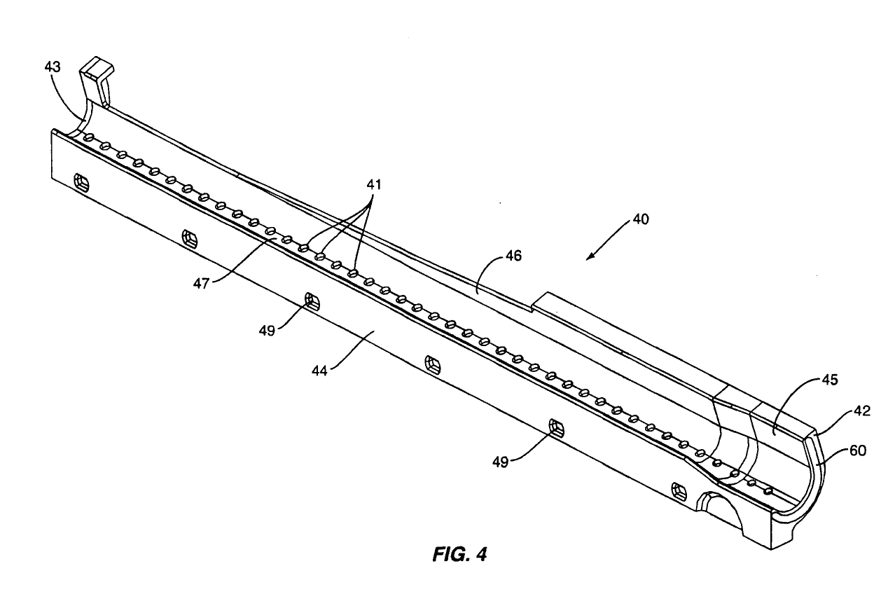

Gutter 40 includes a bottom section 47 that is positioned vertically below the auger 20, and a sidewall 46 that extends around a lateral section of the auger 20. The height of the sidewall 46 may vary along the length of the gutter 40. As illustrated in FIGS. 3 and 4, the height is greatest at the first end 42 and smallest at the second end 43. At the first end 42, the sidewall 46 may extend above the blades 32 of the auger 20 to prevent or greatly reduce any toner that may escape over the sidewall 46. At the second end 43, the auger 20 extends above the sidewall 46 that may allow more of the toner to escape over the sidewall 46. The changes in height are to evenly spread the toner along the length of the reservoir 20 as will be explained below.

Apertures 41 are spaced along the length of the bottom section 47 between the first and second ends 42, 43. The apertures 41 are sized for the toner to fall through and into the lower section of the toner reservoir 20 that is vertically below the gutter 40. In one embodiment as illustrated in FIG. 4, the apertures 41 are positioned in a straight row.

The shape, size, and location of the apertures 41 provide for distribution of the toner along the toner reservoir 20. In general, the amount of toner moving along the gutter 40 is greatest at the first end 42 and slowly decreases along the length towards the second end 43 due to some of the toner passing through the apertures 41. In one embodiment, the apertures 41 at the first end 42 may include a smaller size than the other apertures 41. In one embodiment, the first four apertures 41 include a diameter of about 1.8 mm, the next five apertures 41 include a diameter of about 2.05 mm, and the remaining apertures include a diameter of about 2.2 mm. In this embodiment, the apertures 41 are evenly spaced along the length of the gutter 40.

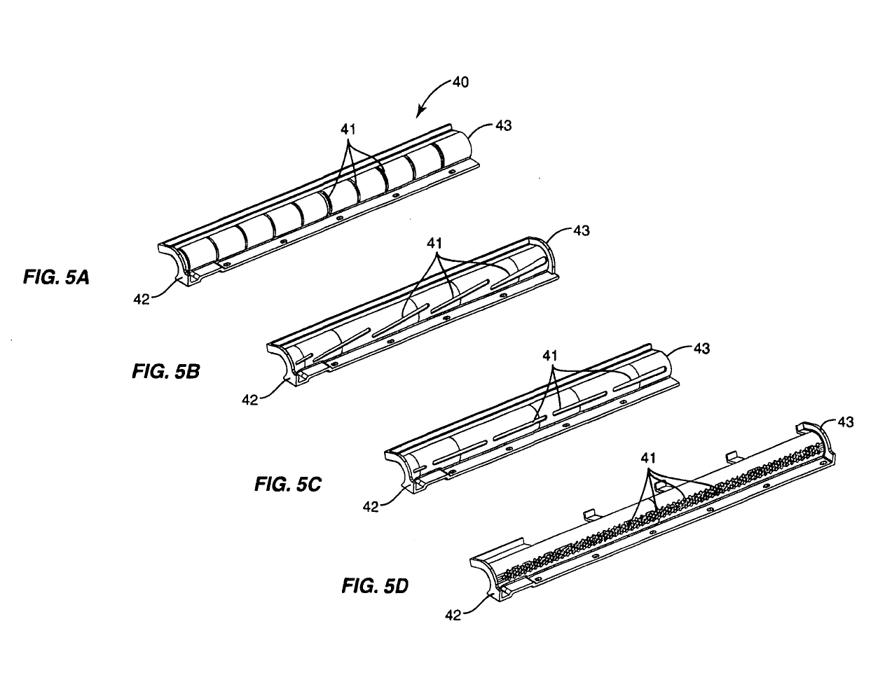

Apertures 41 may include various shapes and sizes. FIG. 4 includes an embodiment with the apertures 41 in a straight row. Apertures 41 towards the first end 42 are larger than apertures 41 towards the second end 43. FIG. 5A includes an embodiment with the apertures 41 formed as slots that are aligned perpendicular to a longitudinal axis of the gutter 40. FIG. 5B includes an embodiment with the apertures 41 formed as slots that are aligned at a transverse angle relative to the longitudinal axis of the gutter 40. FIG. 5C includes apertures 41 formed as slots that are parallel with the longitudinal axis. FIG. 5D includes an embodiment with an arrangement of small apertures 41 aligned in an overlapping configuration. In another embodiment (not illustrated), the gutter 40 includes a single aperture 41 formed as elongated slot.

The sidewall 46 may also provide for the toner to be spread along the length of the gutter 40. The sidewall 46 may include a greater height at the first end 42. This height prevents or greatly reduces the amount of toner that may escape from the gutter 40 over the sidewall 46. Therefore toner along this section of the gutter 40 is distributed mainly through the apertures 41. As the height of the sidewall 46 decreases away from the first end 42, the amount of toner that escapes increases. Therefore, the distribution of toner along these sections is caused by a combination of the apertures 41 and the escape over the sidewall 46. In an embodiment with the second end 43 mounted against the sidewall 20, the toner that moves across the entire length of the gutter 40 builds up at the second end 43 and eventually reaches a height that it escapes over the sidewall 46. The lower height of the sidewall 46 prevents or limits the toner from being packed into and clogging the gutter 40. The apertures 41 may also extend along the sidewall 46.

In one embodiment, the sidewall 46 acts as a pressure release mechanism. Under normal operating conditions, the toner is distributed through the apertures 41. However, if not enough toner exits through the apertures 41, the toner may accumulate and begin to pack in the gutter 40. The toner may accumulate to an amount that prevents rotation of the auger 30. The sidewall 46 allows for accumulated toner to escape from the gutter 40 prior to causing problems with the auger 30 or a possible toner leak.

In another embodiment, the auger 30 and gutter 40 do not extend the entire length of the toner reservoir 20. Therefore, whatever toner remains in the gutter 40 and is being moved by the auger 30 falls off the end of the gutter 40 and into the lower section of the toner reservoir 20. In this embodiment, much of the toner is already distributed through the apertures 41 and over the sidewall 46 prior to reaching the end of the gutter 40. Therefore, the toner is distributed across a section of the toner reservoir 20.

The gutter 40 may be positioned away from the auger 30 to form a gap 39 between the two as illustrated in FIG. 2. The gap 39 is formed between the blades 32 of the auger 30 and the bottom section 47. The gap 39 also extends between the blades 32 and the sidewall 46 of the gutter 40. The gap 39 should be as small as possible to still allow the auger 30 to move the toner through he apertures 41. If the gap 39 is too large, the auger 30 does not effectively move the toner through the apertures 41. In one embodiment, the gap 39 is about 1.2 mm. The gap 39 facilitates the ability of the auger 30 to move the toner through the apertures 41. The gap may also prevent noise that would occur if the rotating auger 30 contacted the gutter 40.

Gutter 40 may further include a flange 44 for attaching the gutter 40 to the toner reservoir 20. As illustrated in FIG. 2, the flange 44 abuts against the inner edge of one of the sidewalls 22. Apertures 49 may be positioned along the length of the flange 44 to facilitate the attachment. The gutter 40 may be attached to the toner reservoir 20 in various manners, including but not limited to heat staking, adhesive, screws, rivets, and vibratory welding. In another embodiment, the gutter 40 is molded as part of the toner reservoir 20. The positioning of the gutter 40 against the inner edge of the sidewall 22 may form a wall opposing sidewall 46 to prevent toner from escaping from the gutter 40.

A seal 60 as illustrated in FIG. 4 may be positioned between the first end 42 and the inner edge of the sidewall 22 to prevent toner from leaking as it is introduced onto the gutter 40. In one embodiment, the seal 60 is constructed from foam.

In use, toner at the inlet 21 is moved along the gutter 40 and into the toner reservoir 20 by the auger 30. As the toner moves along the gutter 40, the toner falls through the apertures 21. Further, the movement of the toner along the gutter 40 may cause the toner to accumulate to a height that the toner escapes over the sidewall 46 and falls vertically into the lower reaches of the toner reservoir 20.

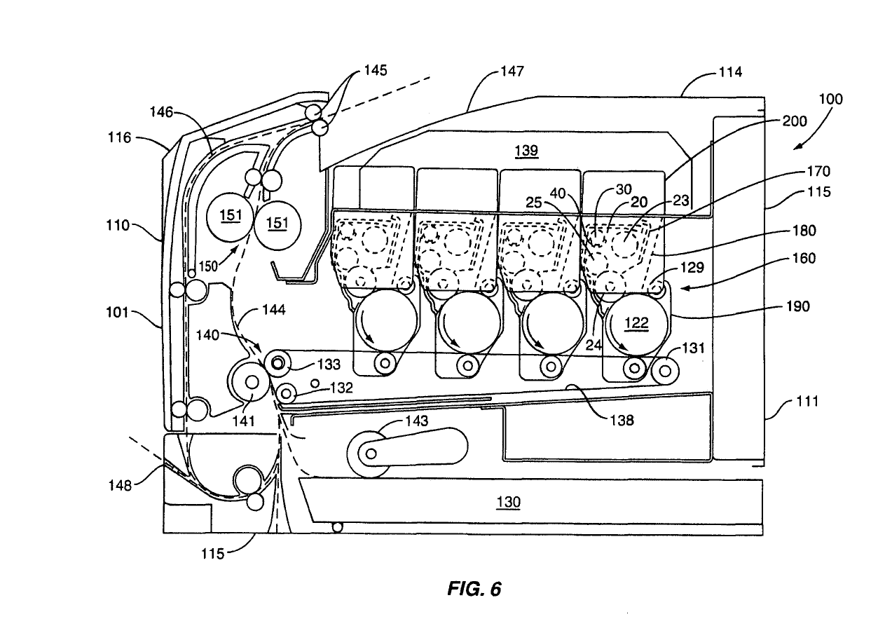

A more complete understanding of the toner reservoir 20, auger 30, and gutter 40 may be obtained through an understanding of the image formation process. FIG. 6 illustrates one embodiment of an image forming apparatus 100. The apparatus 100 includes a media input tray 130 positioned in a lower section of a body 101. The tray 130 is sized to contain a stack of media sheets that will receive color and/or monochrome images. The media input tray 130 is preferably removable for refilling. A control panel 116 may be located on the front 110 of the body 101. Using the control panel 116, the user is able to enter commands and generally control the operation of the image-forming device 100.

A first toner transfer area 160 includes one or more imaging stations 180 that are aligned horizontally extending from the front 110 to the back 111 of the body 101. Each imaging station 180 includes a developer unit 170, a photoconductor unit 190, and a toner cartridge 200. Each of the imaging stations 180 is mounted such that photoconductive (PC) drums 122 are substantially parallel. For purposes of clarity, the developer unit 170, photoconductor unit 190, and toner cartridge 200 are labeled on only one of the imaging stations 180. In one embodiment, each of the imaging stations 180 is substantially the same except for the color of toner.

The developer unit 170 includes the toner reservoir 20, auger 30, and gutter 40. In this embodiment, the developer unit 170 also includes the metering member 23, developer roll 24, and toner adder roll 25. The photoconductor unit 190 includes a charging roll 129 and the PC drum 122.

The charging roll 129 forms a nip with the PC drum 122, and charges the surface of the PC drum 122 to a specified voltage such as −1000 volts, for example. A laser beam from a printhead 139 is directed to the surface of the PC drum 122 and discharges those areas it contacts to form a latent image. In one embodiment, areas on the PC drum 122 illuminated by the laser beam are discharged to approximately −300 volts. Toner in the toner reservoir 20 is moved to the developer roll 24, which also forms a nip with the PC drum 122, then transfers the toner to the PC drum 122 to form a toner image. The toner is attracted to the areas of the PC drum 122 surface discharged by the laser beam from the printhead 139.

An intermediate transfer mechanism (ITM) 138 is disposed adjacent to each of the imaging stations 180. In this embodiment, the ITM 138 is formed as an endless belt trained about support roll 131, tension roll 132 and back-up roll 133. During image forming operations, the ITM 138 moves past the imaging stations 180 in a clockwise direction as viewed in FIG. 1. One or more of the PC drums 122 apply toner images in their respective colors to the ITM 138. In one embodiment, a positive voltage field attracts the toner image from the PC drums 122 to the surface of the moving ITM 138.

The ITM 138 rotates and collects the one or more toner images from the imaging stations 180 and then conveys the toner images to a media sheet at a second transfer area. The second transfer area includes a second transfer nip 140 formed between the back-up roll 133 and a second transfer roll 141.

A media path 144 extends through the device 100 for moving the media sheets through the imaging process. Media sheets are initially stored in the input tray 130 or introduced into the body 101 through a manual feed 148. The sheets in the input tray 130 are picked by a pick mechanism 143 and moved into the media path 144. In this embodiment, the pick mechanism 143 includes a roll positioned at the end of a pivoting arm. The roll rotates to move the media sheets from input tray 130 towards the second transfer area. In one embodiment, the pick mechanism 143 is positioned in proximity (i.e., less than a length of a media sheet) to the second transfer area with the pick mechanism 143 moving the media sheets directly from the input tray 130 into the second transfer nip 140. For sheets entering through the manual feed 148, one or more rolls are positioned to move the sheet into the second transfer nip 140.

The media sheet receives the toner image from the ITM 138 as it moves through the second transfer nip 140. The media sheets with toner images are then moved along the media path 144 and into a fuser area 150. Fuser area 150 includes fusing rolls or belts 151 that form a nip to adhere the toner image to the media sheet. The fused media sheets then pass through exit rolls 145 that are located downstream from the fuser area 150. Exit rolls 145 may be rotated in either forward or reverse directions. In a forward direction, the exit rolls 145 move the media sheet from the media path 144 to an output area 147. In a reverse direction, the exit rolls 145 move the media sheet into a duplex path 146 for image formation on a second side of the media sheet.

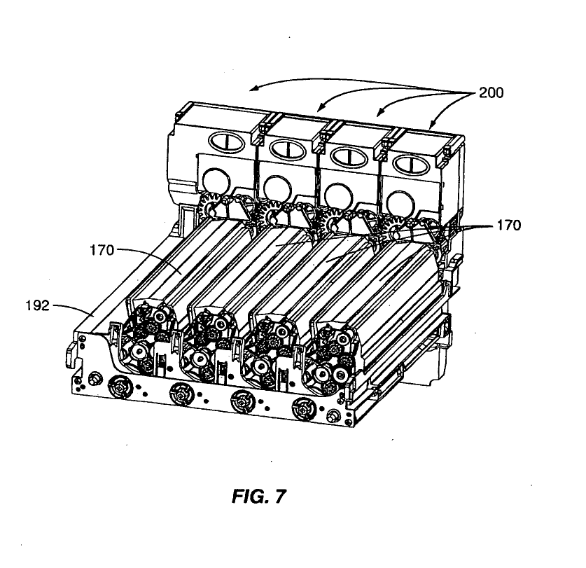

FIG. 7 illustrates four imaging stations 180 mounted within a frame 192. The frame 192 is mounted in the body 101 of the imaging forming apparatus 100 to position the cartridges 200 in an accessible location for removing and replacing the cartridges 200. After the toner in the cartridges 200 has been moved into the toner reservoir 20, the depleted cartridge 200 is removed and replaced. This provides for the functional elements in the developer unit 170, such as the developer roll 24 and toner adder roll 25, to have an extended life and not be replaced when the toner in the toner reservoir 20 becomes depleted.

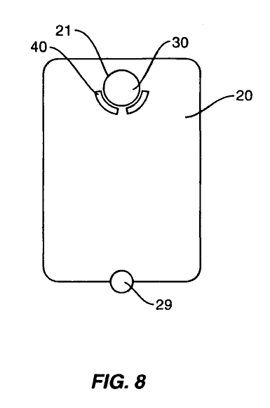

In the embodiments described above, the metering member 23, developer roll 24, toner adder roll 25, auger 30, and gutter 40 are each positioned in the toner reservoir 20. The toner reservoir 20 may include various elements. FIG. 8 includes another embodiment with just the auger 30 and the gutter 40 positioned at the inlet 21 into the toner reservoir 20 and being vertically above the outlet 29 through which the toner exits.

In another embodiment, the auger 30 and gutter 40 are used in a toner reservoir 20 that is part of a toner cartridge that also includes a developer roll, PC drum, and charging roll.

In one embodiment, an agitating member is positioned within the toner reservoir 20 to agitate and move the toner. The agitating member includes one or more arms that extend outward from a central shaft.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A device to move toner within a toner reservoir of an image forming apparatus, the device comprising:
an elongated auger with an auger first end and an auger second end, the auger including a helical blade to move the toner from the first end towards the second end;
a gutter positioned adjacent to the auger and including a bottom section positioned vertically below the auger and a sidewall that extends upward along a lateral side of the auger, the gutter including an elongated shape with a gutter first end and a gutter second end; and
apertures positioned along the bottom section of the gutter between the gutter first and second ends, each of the apertures sized to allow toner that is moved by the auger to fall through the gutter and into the reservoir.

2. The device of claim 1, wherein an outer diameter of the auger is larger at the auger first end than at the auger second end.

3. The device of claim 1, wherein the auger is spaced away from the gutter with a gap formed between the auger and the gutter.

4. The device of claim 1, wherein the apertures comprise at least a first aperture and a second aperture, the first aperture positioned closer to the gutter first end than the second aperture and being smaller than the second aperture.

5. The device of claim 1, wherein the apertures comprise at least a first series of apertures and a second series of apertures, the first series of apertures positioned closer to the gutter first end than the second series of apertures and being smaller than the second series of apertures.

6. The device of claim 1, wherein the apertures are positioned in a straight row along the bottom section of the gutter.

7. The device of claim 1, wherein the sidewall includes a greater height at the gutter first end than at the gutter second end.

8. A device to move toner within an image forming apparatus, the device comprising:
a toner reservoir including an upper section vertically above a lower section and an inlet in a sidewall that leads into the upper section;
an elongated auger with an auger first end positioned at the inlet and an auger second end positioned away from the inlet, the auger including a helical blade to move the toner from the inlet and into the toner reservoir;
a gutter positioned adjacent to the auger and including a bottom section positioned vertically below the auger and a sidewall that extends upward along a lateral side of the auger, the gutter including an elongated shape with a gutter first end attached to the sidewall and a gutter second end; and
apertures positioned along the bottom section of the gutter between the gutter first and second ends, each of the apertures sized to allow toner that is moved from the inlet by the auger to fall through the gutter and into the lower section of the toner reservoir.

9. The device of claim 8, wherein the apertures comprise at least a first aperture and a second aperture, the first aperture positioned closer to the inlet than the second aperture and being smaller than the second aperture.

10. The device of claim 8, wherein the apertures comprise at least a first series of apertures and a second series of apertures, the first series of apertures positioned closer to the inlet than the second series of apertures and being smaller than the second series of apertures.

11. The device of claim 8, wherein the apertures are positioned in a straight row along the bottom section of the gutter.

12. The device of claim 8, wherein the sidewall includes a greater height at the inlet than at the gutter second end.

13. The device of claim 8, wherein the gutter extends along a length of the upper section of the toner reservoir with the gutter second end attached to a second sidewall of the toner reservoir opposite from the inlet.

14. The device of claim 13, wherein the auger second end is positioned at the second sidewall of the toner reservoir.

15. The device of claim 8, wherein the apertures comprise at least a first aperture and a second aperture, the first and second apertures including different shapes.

16. The device of claim 8, wherein the auger extends through the inlet in the sidewall of the toner reservoir with the auger first end positioned on an exterior of the toner reservoir.

17. A method of moving toner within an image forming apparatus comprising:
rotating an auger and moving the toner along a gutter that extends laterally along an upper section of a toner reservoir;
moving a first amount of the toner into a first aperture in a bottom section of the gutter and causing the first amount of the toner to vertically fall through the aperture and into a first lateral location in a lower section of the toner reservoir;
moving a second amount of the toner further along the gutter and into a second aperture in the bottom section of the gutter that is spaced laterally away from the first aperture and causing the second amount of the toner to vertically fall through the aperture and into a second lateral location in the lower section of the toner reservoir; and
moving a third amount of the toner even farther along the gutter and into a third aperture in the bottom section of the gutter that is spaced laterally away from the second aperture and causing the third amount of the toner to vertically fall through the aperture and into a third lateral location in the lower section of the toner reservoir.

18. The method of claim 17, further comprising moving a fourth amount of the toner along the gutter past the third aperture and over a sidewall of the gutter and causing the fourth amount of the toner to vertically fall into a fourth lateral location in the lower section of the toner reservoir.

19. The method of claim 17, further comprising distributing equal amounts of the toner to each of the lateral locations in the lower section of the toner reservoir.

20. The method of claim 17, further comprising preventing an amount of the toner from escaping over a sidewall of the gutter in proximity to the first aperture and allowing the amount of the toner to escape over sidewall at the third aperture.
